(19) United States
(12) Patent Application Publication
(10) Pub. No.: US 2013/0261030 A1
(43) Pub. Date: Oct. 3, 2013

(54) Fluids for use with High-frequency Downhole Tools

(71) Applicant: Baker Hughes Incorporated, Houston, TX (US)

(72) Inventors: Othon Monteiro, Houston, TX (US); Daniel R. Ellis, Crosby, TX (US)

(21) Appl. No.: 13/903,692

(22) Filed: May 28, 2013

Related U.S. Application Data
(63) Continuation-in-part of application No. 13/545,706, filed on Jul. 10, 2012.
Application No. 13/545,706 is a continuation-in-part of application No. 13/424,549, filed on Mar. 20, 2012.
(60) Provisional application No. 61/656,733, filed on Jun. 7, 2012.
(60) Provisional application No. 61/466,259, filed on Mar. 22, 2011.

(51) Int. Cl. C09K 8/03; C09K 8/82

(52) U.S. Cl. CPC C09K 8/03; C09K 8/82
USPC 507/105; 507/203; 507/103; 507/259; 507/260; 507/135; 507/267; 507/209; 507/110; 507/136; 507/261; 507/235; 507/128; 507/239; 507/129; 507/258; 507/134; 507/205; 507/266; 507/139; 507/252

(57) ABSTRACT

A fluid may contain nanoparticles and a base fluid where the base fluid may be a non-aqueous fluid. The base fluid may be, but is not limited to a drilling fluid, a completion fluid, a production fluid, and/or a stimulation fluid. The fluid may have at least one property, such as but not limited to a dielectric constant ranging from about 5 to about 10,000, an electrical conductivity ranging from about 1×10⁻⁶ S/m to about 1 S/m, and combinations thereof. The non-aqueous fluid may be a brine-in-oil emulsion, or a water-in-oil emulsion, and combinations thereof. The addition of nanoparticles to the base fluid may modify the electrical properties of the fluid.

### CROSS-REFERENCE TO RELATED APPLICATIONS

This application claims the benefit of Provisional Patent Application No. 61/656,733 filed Jun. 7, 2012; and is a continuation-in-part of U.S. patent application Ser. No. 13/545,706, entitled ELECTRICALLY CONDUCTIVE OIL-BASE FLUIDS FOR OIL AND GAS APPLICATIONS, filed on Jul. 10, 2012; which is a continuation-in-part of U.S. patent application Ser. No. 13/424,549, entitled “GRAPHENE-CONTAINING FLUIDS FOR OIL AND GAS EXPLORATION AND PRODUCTION”, filed on Mar. 20, 2012, which claimed the benefit of U.S. Provisional Application Ser. No. 61/466,259 filed Mar. 22, 2011; all of which are herein incorporated by reference in their entirety.

### TECHNICAL FIELD

The present invention relates to a fluid composition and a method for modifying the electrical conductivity and/or the dielectric constant of a base fluid by adding nanoparticles to the base fluid where the base fluid may be a non-aqueous fluid and has at least one property, such as but not limited to, a relative dielectric constant ranging from about 5 to about 10,000, an electrical conductivity ranging from about 1×10⁻⁶ S/m to about 1 S/m, and combinations thereof.

### BACKGROUND

Fluids used in the drilling, completion, production, and remediation of subterranean oil and gas wells are known. It will be appreciated that within the context herein, the term “fluid” also encompasses “drilling fluids”, “completion fluids”, “workover fluids”, “servicing fluids”, “production fluids”, and “remediation fluids”.

Drilling fluids are typically classified according to their base fluid and are used for drilling operations to drill boreholes into the earth. In water-based fluids, solid particles are suspended in a continuous phase consisting of water or brine. Oil can be emulsified in the water which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

“Oil-based fluid” is used herein to include fluids having a non-aqueous continuous phase where the non-aqueous continuous phase is all oil, a non-aqueous fluid, a water-in-oil emulsion, a water-in- non-aqueous emulsion, a brine-in-oil emulsion, or a brine-in- non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types. For some applications, in particular for the use of some wellbore imaging tools, it is important to modify or control the frequency (either by altering the resistivity and/or the dielectric strength) of the oil-based fluid.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the well-bore. A regular drilling fluid is usually not compatible for completion operations because of its solid content, pH, and ionic composition.

Completion fluids also help place certain completion-related equipment, such as gravel packs, without damaging the producing subterranean formation zones. Conventional drilling fluids are rarely suitable for completion operations due to their solids content, pH, and ionic composition. The completion fluid should be chemically compatible with the subterranean reservoir formation and its fluids. Modifying the frequency of completion fluids may allow the use of downhole tools for facilitating final operations.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

Despite the ability to measure deeper into the formation, the resolution of these tools is still strongly affected by the properties of the fluid within which the imaging tool is used. In order to meet the challenges encountered in the imaging of drilled formations, advanced electrical imaging tools have been developed that operate within a fluid having modified electrical conductivity and modified dielectric constant to obtain a signal at a desired frequency. Different tools require different fluid properties for maximizing the performance of the tools. For instance, tools that operate at low-frequencies (e.g. 10 kHz or lower) require fluids having a low-resistivity; whereas, tools that operate at high-frequency (e.g. 100 kHz or higher) require fluids having a high resistivity and a high dielectric constant.

It would be desirable if the electrical properties of the aforementioned fluids could be tailored to modify their electrical properties, such as but not limited to the electrical conductivity and/or dielectric constant of drilling fluids, completion fluids, servicing fluids, and combinations thereof and thereby enhance the performance of these imaging tools in one example.

### SUMMARY

There is provided, in one non-limiting form, a fluid that may include a non-aqueous base fluid and nanoparticles. The non-aqueous base fluid may be or include, but is not limited to an oil-based fluid, a brine-in-oil emulsion, a brine-in-nonaqueous fluid emulsion, a water-in-oil emulsion, and combinations thereof. The nanoparticles may be or include, but are not limited to graphene, graphene platelets, graphene oxide, nanorods, nanoplatelets, nanoclays, nano-oxides, nano-nitrides, and combinations thereof. The fluid composition may have at least one property, such as but not limited to, a relative dielectric constant ranging from about 5 to about 10,000, an electrical conductivity ranging from about 1×10⁻⁶ S/m to about 1 S/m, and combinations thereof.

In an alternative non-limiting embodiment, the fluid may include a nanoparticle blend having nanoparticles and an additional component that is different from the nanoparticles. The additional component may be or include, but is not limited to nanotubes, graphite, micro-nitrides, and combinations thereof. In a further non-limiting embodiment, the fluid may include a surfactant in an amount effective to suspend the nanoparticles or nanoparticle blend into the base fluid. The nanoparticle blend may improve the performance of a high-frequency downhole tool as compared to an otherwise identical fluid absent the nanoparticle blend.

In another non-limiting form, a method is provided where nanoparticles maybe added to a non-aqueous base fluid in an effective amount to improve the performance of a high-frequency downhole tool as compared to an otherwise identical fluid absent the nanoparticles. The non-aqueous base fluid may be, but is not limited to an oil-based fluid, a brine-in-oil emulsion, a brine-in-nonaqueous fluid emulsion, a water-in-oil emulsion, and combinations thereof. The nanoparticles may be or include, but are not limited to graphene, graphene platelets, graphene oxide, nanorods, nanoplatelets, nanoclays, nano-titanium oxide platelets, nano-oxides, nano-nitrides, and combinations thereof.

In a non-limiting embodiment, the fluid may include a nanoparticle blend having nanoparticles and an additional component that is different from the nanoparticles. The additional component may be or include, but is not limited to nanotubes, graphite, micro-nitrides, and combinations thereof. A surfactant may be added to the fluid in an amount effective to suspend the nanoparticles or nanoparticle blend into the base fluid. The nanoparticle blend may improve the performance of a high-frequency downhole tool as compared to an otherwise identical fluid absent the nanoparticle blend.

### BRIEF DESCRIPTION OF THE DRAWINGS

FIG. 1 is a graph illustrating the frequency-dependent resistivity when a dispersion of graphene was prepared in mineral oil, which is a typical base fluid for drilling fluids; and

FIG. 2 is a graph illustrating the frequency-dependent dielectric constant of a mineral oil having an amount of graphene added thereto.

### DETAILED DESCRIPTION

The electrical properties, e.g. dielectric constant and electrical conductivity, of a complex fluid, having at least one fluid phase and nanoparticles may be dependent on the frequency of the voltage or current applied to the fluid when obtaining the measurements of the property. It has been discovered that certain compositions of complex fluids can have low resistivity at low frequency and high resistivity and high dielectric constant at high frequency. The electric or dielectric properties of fluids are dependent on the frequency at which these properties are measured. ‘Electrical property’ or ‘electrical properties’ as used herein are defined to include dielectric constant (or specific inductive capacity), dielectric loss, loss factor, power factor, a.c. conductivity, d.c. conductivity, electrical breakdown strength, and other equivalent and similar properties.

This is important because many downhole tools, such as imaging tools in a non-limiting example, utilize an alternating current (a.c.) with a high frequency, so the fluids used in conjunction with these tools need to have a particular electrical conductivity and have a particular dielectric constant for the tool to function and to achieve maximum resolution. The properties of the fluid may be modified by adding electrically conductive nanoparticles and/or non-electrically conductive nanoparticles to the base fluid, such that the use of a downhole tool, such as a measuring while drilling tool, in a non-limiting example, in non-aqueous fluids may be permitted or perform better. The type of nanoparticles depends on the desired properties of the fluid.

The electrical conductivity and/or dielectric constant of the fluid are important in relation to the high frequency downhole tools because these tools are designed to operate with fluids having properties within a certain range of values. If the actual value of dielectric constant or electrical conductivity (the inverse of resistivity) is outside a particular range, real changes in resistivity of formation are not detected either because of a very low signal to noise ratio, or because preferential paths for current transmission may develop. In both cases, the capability of discrimination between zones with different resistivity becomes compromised, and resolution deteriorates; eventually, the high frequency downhole tool does not properly function in this type of environment.

In one non-limiting example, the resolution from a high frequency downhole tool, such as a measuring-while-drilling tool, increases when altering the resistivity and/or the dielectric strength according to the formula [resistivity×(dielectric strength)²]. In other words, the resolution of the tools may be improved by altering the electrical conductivity (the inverse of resistivity) or the dielectric constant of the fluid by adding the nanoparticles to the base fluid. For example, a fluid for use with a high frequency downhole tool may have at least one property, such as but not limited to, a relative dielectric constant ranging from about 5 to about 10,000, an electrical conductivity ranging from about 1×10⁻⁶ S/m to about 1 S/m, and combinations thereof.

The dispersion of nano-materials, into at least one phase of the non-aqueous fluid, such as the continuous phase in a non-limiting embodiment, will alter the electrical properties of the non-aqueous fluid. These properties may be measured when a voltage or current is applied to the fluid at a frequency ranging from about 10 kHz to about 100 MHz, alternatively from about 100 kHz independently to about 10 MHz. The addition of nanoparticles to the fluid may alter the electric properties of the composite fluid, which may be determined by the content and the inherent properties of the dispersed phase content, and may be tailored to have desirable values. The modified electrical properties of the fluid may enable better use of the downhole tools as compared to usage of the tools without modification of these properties by means of the addition of the nanoparticles. Moreover, the modified properties of the fluid may improve the performance of the downhole tools by improving the resolution of these tools as compared to an otherwise identical fluid absent the nanoparticles. “Independently” as used herein means that any lower threshold may be combined with any upper threshold to define an acceptable alternative range.

The nanoparticles to be added to the base fluid may be or include electrically conductive nanoparticles, such as but not limited to graphene, graphene platelets, graphene oxide, nanorods, nanoplatelets, nanoclays, nano-titanium oxide platelets, nano-oxides, nano-nitrides, and combinations thereof. Boro-nitride is a non-limiting example of one type of nano-nitrides. In an alternative embodiment, the nanoparticles may be non-electrically conductive nanoparticles, such as but not limited to functionalized graphene, functionalized graphene platelets, functionalized graphene oxide, nanorods, nanoplatelets, nanoclays, nano-titanium oxide platelets, nano-oxides, nano-nitride, and combinations thereof. In another non-limiting embodiment, the nanoparticles may be a component of a nanoparticle blend where the nanoparticle blend may also include an additional component. The additional component may be different from the nanoparticles and may be or include, but is not limited to nanotubes, graphite, micro-nitrides, and combinations thereof.

The graphite may be or include, but is not limited to micro-crystalline graphite, nano-crystalline graphite, and combinations thereof. The size of the graphite may range from about 100 nm independently to about 100 μm. The nanotubes, nanorods, and/or the nanoplatelets may be metallic, ceramic, or combinations thereof in an alternative embodiment. In one non-limiting embodiment, the nanotubes are carbon nanotubes.

The amount of nanoparticles added to the fluid may range from about 0.0001 wt % to about 10 wt % to alter the electrical conductivity of the fluid. In a non-limiting embodiment, the nanoparticles may be added in an amount ranging from about 0.001 wt % to about 5 wt %, alternatively from about 0.01 wt % to about 2 wt %.

The base fluid may be a non-aqueous fluid. The non-aqueous fluid may be an oil, a brine-in-oil emulsion, or a water-in-oil emulsion, and combinations thereof. In a non-limiting example, the base fluid may be selected from the group consisting of a drilling fluid, completion fluid, a production fluid, a servicing fluid, a stimulation fluid, and combinations thereof.

The nanoparticles may be chemically-modified nanoparticles, covalently-modified nanoparticles, physically modified nanoparticles, functionalized nanoparticles, and combinations thereof. The modification and/or functionalization of the nanoparticles may improve the dispersibility of the nanoparticles in a non-aqueous fluid by stabilizing the nanoparticles in suspension, which avoids undesirable flocculation as compared with otherwise identical nanoparticles that have not been modified or functionalized. In one non-limiting embodiment of the invention, it is desirable that the electrical conductivity and/or dielectric constant of the fluid be approximately uniform; this requires the distribution of the nanoparticles to be approximately uniform. If the nanoparticles flocculate, drop out, or precipitate, the electrical conductivity and/or dielectric constant of the composite fluid may change. Alternatively, the nanoparticles may be functionalized or modified to alter the electrical conductivity or dielectric constant of the fluid once the nanoparticles are added thereto, such as but not limited to functionalized graphene, functionalized graphene platelets, functionalized graphene oxide, and combinations thereof.

Graphene is an allotrope of carbon, whose structure is a planar sheet of sp²-bonded carbon atoms that are densely packed in a 2-dimensional honeycomb crystal lattice. The term “graphene” is used herein to include particles that may contain more than one atomic plane, but still with a layered morphology, i.e. one in which one of the dimensions is significantly smaller than the other two, and also may include any graphene that has been chemically modified, physically modified, covalently modified, and/or functionally modified. Although there is no exact maximum number of layers in graphene, a typical maximum number of monoatomic-thick layers in the graphene nanoparticles here is between fifty (50) and one hundred (100). The structure of graphene is hexagonal, and graphene is often referred as a 2-dimensional (2-D) material. The 2-D morphology of the graphene nanoparticles is of utmost importance when carrying out the useful applications relevant to the graphene nanoparticles. The applications of graphite, the 3-D version of graphene, are not equivalent to the 2-D applications of graphene. The graphene may have at least one graphene sheet, and each graphene platelet may have a thickness no greater than 100 nm.

Graphene is in the form of one-atomic layer thick or multi-atomic layer thick platelets. Graphene platelets may have in-plane dimensions ranging from sub-micrometer to about 100 s micrometers. These types of platelets share many of the same characteristics as carbon nanotubes. The platelet chemical structure makes it easier to functionalize or modify the platelet for enhanced dispersion in polymers. Graphene platelets provide electrical conductivity that is similar to copper, but the density of the platelets is about four times less than that of copper, which allows for lighter materials. The graphene platelets are also fifty (50) times stronger than steel with a surface area that is twice that of carbon nanotubes.

Carbon nanotubes are defined herein as allotropes of carbon consisting of one or several single-atomic layers of graphene rolled into a cylindrical nanostructure. Nanotubes may be single-walled, double-walled or multi-walled.

Electrical conductivity and dielectric constant of graphene have been measured and compare well with those of carbon nanotubes. The 2-D morphology, however, provides significant benefits when dispersed in complex fluids, such as multi-phasic fluids or emulsions. Unique to this application is the engineering of the graphene dispersion within the non-conducting phase of the fluid, to achieve the desirable properties.

In the present context, the nanoparticles may have at least one dimension less than 100 nm, although other dimensions may be larger than this. In a non-limiting embodiment, the nanoparticles may have one dimension less than 50 nm, or alternatively about 30 nm. In one non-limiting instance, the smallest dimension of the nanoparticles may be less than 5 nm, but the length of the nanoparticles may be much longer than 100 nm, for instance 25000 nm or more. Such nanoparticles would be within the scope of the fluids herein.

Nanoparticles typically have at least one dimension less than 100 nm (one hundred nanometers). While materials on a micron scale have properties similar to the larger materials from which they are derived, assuming homogeneous composition, the same is not true of nanoparticles. An immediate example is the very large interfacial or surface area per volume for nanoparticles. The consequence of this phenomenon is a very large potential for interaction with other matter, as a function of volume. For nanoparticles, the surface area may be up to about 1800 m²/g. Additionally, because of the very large surface area to volume present with graphene, it is expected that in most, if not all cases, much less proportion of graphene nanoparticles need be employed relative to micron-sized additives conventionally used to achieve or accomplish a similar effect.

Nevertheless, it should be understood that surface-modified nanoparticles may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the nanoparticle, which differs from the properties of the surface of the unprocessed nanoparticle.

The nanoparticles may be functionally modified to introduce chemical functional groups thereon, for instance by reacting the graphene nanoparticles with a peroxide such as diacyl peroxide to add acyl groups which are in turn reacted with diamines to give amine functionality, and may be further reacted. Functionalized nanoparticles are defined herein as those which have had their edges or surfaces modified to contain at least one functional group including, but not necessarily limited to, sulfonate, sulfate, sulfosuccinate, thiosulfate, succinate, carboxylate, hydroxyl, glucoside, ethoxylate, propoxylate, phosphate, ethoxylate, ether, amines, amides, ethoxylate-propoxylate, an alkyl, an alkenyl, a phenyl, a benzyl, a perfluoro, thiol, an ester, an epoxy, a keto, a lactone, a metal, an organo-metallic group, an oligomer, a polymer, or combinations thereof.

Introduction of functional groups by derivatizing the olefinic functionality associated with the nanoparticles may be effected by any of numerous known methods for direct carbon-carbon bond formation to an olefinic bond, or by linking to a functional group derived from an olefin. Exemplary methods of functionalizing may include, but are not limited to, reactions such as oxidation or oxidative cleavage of olefins to form alcohols, diols, or carbonyl groups including aldehydes, ketones, or carboxylic acids; diazotization of olefins proceeding by the Sandmeyer reaction; intercalation/metallization of a nanodiamond by treatment with a reactive metal such as an alkali metal including lithium, sodium, potassium, and the like, to form an anionic intermediate, followed by treatment with a molecule capable of reacting with the metalized nanodiamond such as a carbonyl-containing species (carbon dioxide, carboxylic acids, anhydrides, esters, amides, imides, etc.), an alkyl species having a leaving group such as a halide (Cl, Br, I), a tosylate, a mesylate, or other reactive esters such as alkyl halides, alkyl tosylates, etc.; molecules having benzylic functional groups; use of transmetalated species with boron, zinc, or tin groups which react with e.g., aromatic halides in the presence of catalysts such as palladium, copper, or nickel, which proceed via mechanisms such as that of a Suzuki coupling reaction or the Stille reaction; pericyclic reactions (e.g., 3 or 4+2) or thermocyclic (2+2) cycloadditions of other olefins, dienes, heteroatom substituted olefins; and combinations thereof.

It will be appreciated that the above methods are intended to illustrate the concept of introducing functional groups to a nanoparticle, and should not be considered as limiting to such methods.

Prior to functionalization, the nanoparticle may be exfoliated. Exemplary exfoliation methods include, but are not necessarily limited to, those practiced in the art such as, but not limited to, fluorination, acid intercalation, acid intercalation followed by thermal shock treatment, and the like. Exfoliation of the nanographene provides a nanographene having fewer layers than non-exfoliated nanographene.

The effective medium theory states that properties of materials or fluids comprising different phases can be estimated from the knowledge of the properties of the individual phases and their volumetric fraction in the mixture. In particular if a conducting particle is dispersed in a dielectric fluid, the electrical conductivity of the dispersion will slowly increase for small additions of nanoparticles. As nanomaterials are continually added to the dispersion, an increase in conductivity is typically observed. This concentration is often referred to as the percolation limit.

In the case of thermal and electrical conductivity of nanofluids (i.e. dispersion of nanomaterials in fluids), the percolation limit decreases with decreasing the size of the nanomaterials. This dependence of the percolation limit on the concentration of the nanoparticles holds for other fluid properties that depend on inter-particle average distance.

There is also a strong dependence on the shape of the nanoparticles dispersed within the phases for the percolation limit of nano-dispersions. The percolation limit shifts further towards lower concentrations of the dispersed phase if the nanoparticles have characteristic 2-D (platelets) or 1-D (nanotubes or nanorods) morphology. Nanotubes and nanorods may not be strictly 1-D as there is width dimension, though small. Similarly platelets do have a thickness, though small. The nanotubes, nanorods, and/or platelets primarily have 1 or 2 dimensions. Thus, the amount of 2-D or 1-D nanomaterials necessary to achieve a certain change in property is significantly smaller than the amount of 3-D nanomaterials that would be required to accomplish a similar effect.

In one sense, such fluids have made use of nanoparticles for many years, since the clays commonly used in drilling fluids are naturally-occurring, e.g. 1 nm thick discs of aluminosilicates. Such nanoparticles exhibit extraordinary rheological properties in water and oil. However, in contrast, the nanoparticles that are the main topic herein are nanoparticles where size, shape and chemical composition are carefully controlled and give a particular property or effect.

These nanoparticles are dispersed in the base fluid. The base fluid may be a drilling fluid, a completion fluid, a production fluid, a stimulation fluid, a servicing fluid, and combinations thereof. The base fluid may be a non-aqueous fluid, or the base fluid may be a single-phase fluid, or a poly-phase fluid, such as an emulsion. The nanoparticles may be used in conventional operations and challenging operations that require stable fluids for high temperature and pressure conditions (HTHP). Such fluids are expected to find uses in, but are not limited to reservoir operations including measuring while drilling tools, reservoir imaging, resistivity logging, drilling fluids, completion fluids, remediation fluids, and reservoir stimulation. It may be helpful in designing new fluids containing engineered nanoparticles to match the amount of the nanoparticles with the proper surfactant/base fluid ratio to achieve the desired dispersion for the particular fluid.

Ways of dispersing colloidal-size particles in fluids is known, but how to disperse nanoparticles within the fluids may be a challenge. The use of surfactants together with the nanoparticles may form self-assembly structures that may enhance the thermodynamic, physical, and rheological properties of these types of fluids. The use of surfactants is generally considered optional, but may be used to improve the quality of the dispersion of the nanoparticles. Such surfactants may be present in the base fluids in amounts from about 0.0001 wt % independently to about 15 wt %, alternatively from about 0.01 wt % independently to about 5 wt %. It is also anticipated that combinations of certain surfactants and nanoparticles will “self-assemble” into useful structures, similar to the way certain compositions containing surfactants self-assemble into liquid crystals of various different structures and orientations.

Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, cleavable surfactants, janus surfactants and extended surfactants, also called extended chain surfactants.

Covalent functionalization may include, but is not necessarily limited to, oxidation and subsequent chemical modification of oxidized nanoparticles, fluorination, free radical additions, addition of carbenes, nitrenes and other radicals, arylamine attachment via diazonium chemistry, and the like. Besides covalent functionalization, chemical functionality may be introduced by noncovalent functionalization, electrostatic interactions, π-π interactions and polymer interactions, such as wrapping a nanoparticle with a polymer, direct attachment of reactants to nanoparticles by attacking the sp² bonds, direct attachment to ends of nanoparticles or to the edges of the nanoparticles, and the like. The amount of nanoparticles in the fluid may range from about 0.0001 wt % independently to about 15 wt %, and from about 0.001 wt % independently to about 5 wt % in an alternate non-limiting embodiment.

The invention will be further described with respect to the following Examples which are not meant to limit the invention, but rather to further illustrate the various embodiments.

### EXAMPLE 1

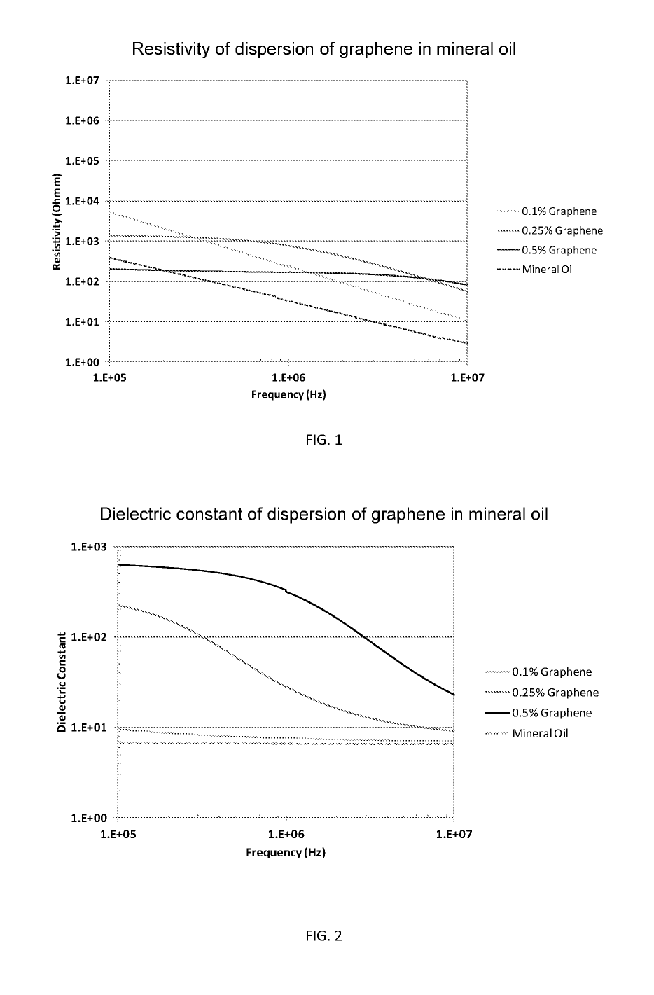

FIG. 1 illustrates the frequency-dependent resistivity when a dispersion of graphene was prepared in mineral oil, which is a typical base fluid for drilling fluids. Four fluids were mixed and each fluid had a different amount of functionalized graphene mixed into the fluid, such as a 0.1% graphene mixture, a 0.25% graphene mixture, a 0.5% graphene mixture, and a control having no graphene added thereto. The graphene was functionalized with an alkane with molecular weight compatible with the mineral oil. The average platelet size of the graphene was about 5 μm. As noted by the figure, the resistivity of each fluid generally decreased with an increase in frequency; the same was true for the control fluid having only mineral oil. Even though the resistivity decreased for each fluid, higher values for resistivity were still achieved with the graphene fluids as opposed to the mineral oil fluid having no graphene.

### EXAMPLE 2

FIG. 2 illustrates the frequency-dependent dielectric constant of a mineral oil based fluid having an amount of graphene added thereto. Four fluids were mixed and each fluid had a different amount of functionalized graphene mixed into the fluid, such as a 0.1% graphene mixture, a 0.25% graphene mixture, a 0.5% graphene mixture, and a control having no graphene added thereto. The graphene was functionalized with and alkane with molecular weight compatible with the mineral oil. The average platelet size of the graphene was about 5 μm. As noted by the figure, the dielectric constant of each fluid generally decreased with an increase in frequency. Different from FIG. 1 though, the mineral oil fluid having no graphene added thereto did not have a noticeable change in dielectric constant. Even though the dielectric constant decreased for each graphene-containing fluid, higher values for dielectric constant were still achieved with the graphene fluids as opposed to the mineral oil fluid having no graphene.

In the foregoing specification, the invention has been described with reference to specific embodiments thereof, and has been suggested as effective in providing effective methods and compositions for improving drilling fluids, completion fluids, production fluids, and servicing fluids used in drilling, completing, producing, and remediating subterranean reservoirs and formations. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of components and/or reaction conditions for forming the nanoparticles, whether modified to have particular shapes or certain functional groups thereon, but not specifically identified or tried in a particular drilling fluid, completion fluid, production fluid, or servicing fluid to improve the properties therein, are anticipated to be within the scope of this invention. Similarly, the fluid components specific types and combinations of components used in the fluids other than the base fluids, nanoparticles, additional components and surfactants mentioned or exemplified may be used in the fluids and methods described herein.

The present invention may suitably comprise, consist or consist essentially of the elements disclosed and may be practiced in the absence of an element not disclosed. For instance, the fluid may consist of or consist essentially of nanoparticles and a non-aqueous base fluid, where the fluid has at least one property, such as but not limited to, a relative dielectric constant ranging from about 5 to about 10,000, an electrical conductivity ranging from about 1×10⁻⁶ S/m to about 1 S/m, and combinations thereof, and the nanoparticles may be or include graphene, graphene platelets, graphene oxide, nanorods, nanoplatelets, nanoclays, nano-titanium oxide platelets, nano-oxides, and combinations thereof, as further defined in the claims. A method for modifying the electrical conductivity and the dielectric constant within a fluid having at least one property, such as but not limited to, a relative dielectric constant ranging from about 5 to about 10,000, an electrical conductivity ranging from about 1×10⁻⁶ S/m to about 1 S/m, and combinations thereof is also disclosed where nanoparticles may be added to a non-aqueous base fluid, and where the nanoparticles may be or include graphene, graphene platelets, graphene oxide, nanorods, nanoplatelets, nanoclays, nano-titanium oxide platelets, nano-oxides, and combinations thereof as further defined in the claims. In each of these examples, the fluid may contain conventional additives.

The words “comprising” and “comprises” as used throughout the claims is to be interpreted as meaning “including but not limited to”.

What is claimed is:

1. A fluid composition comprising:
a non-aqueous base fluid selected from the group consisting of an oil-based fluid, a brine-in-oil emulsion, a brine-in-non-aqueous fluid emulsion, a water-in-oil emulsion, and combinations thereof;
nanoparticles selected from the group consisting of graphene, graphene platelets, graphene oxide, nanorods, nanoplatelets, nanoclays, nano-titanium oxide platelets, nano-oxides, and combinations thereof; and
wherein the fluid composition has at least one property selected from about 5 to about 10,000, an electrical conductivity ranging from about 1×10⁻⁶ S/m to about 1 S/m, and combinations thereof.

2. The fluid composition of claim 1, wherein the fluid further comprises an additional component that is different from the nanoparticles, wherein the additional component is selected from the group consisting of nanotubes, graphite, micro-nitrides, and combinations thereof.

3. The fluid composition of claim 1, wherein the nanoparticles are present in the fluid in an amount effective to improve the performance of a high-frequency downhole tool as compared to an otherwise identical fluid absent the nanoparticles.

4. The fluid composition of claim 1, wherein the base fluid is selected from the group consisting of a drilling fluid, completion fluid, a production fluid, a servicing fluid, and combinations thereof.

5. The fluid composition of claim 1, wherein the nanoparticles have at least one dimension no greater than 100 nm.

6. The fluid composition of claim 1, wherein the nanoparticles are selected from the group consisting of chemically-modified nanoparticles, covalently-modified nanoparticles, functionalized nanoparticles, exfoliated nanoparticles and combinations thereof, wherein the modification and/or functionalization of the nanoparticles alters a characteristic of the nanoparticles selected from the group consisting of improving their dispersibility in a non-aqueous fluid, modifying the electrical conductivity of the nanoparticles, and combinations thereof as compared with otherwise identical nanoparticles that have not been modified or functionalized.

7. The fluid composition of claim 1 wherein the nanoparticles are functionalized nanoparticles having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

8. The fluid composition of claim 1, wherein the nanoparticles are covalently-modified nanoparticles having at least one covalent modification selected from the group consisting of oxidation; free radical additions; addition of carbenes, nitrenes and other radicals; arylamine attachment via diazonium chemistry; and combinations thereof.

9. The fluid composition of claim 1, wherein the nanoparticles are exfoliated by a method selected from the group consisting of fluorination, acid intercalation, acid intercalation followed by thermal shock treatment, and a combination thereof.

10. The fluid composition of claim 1 wherein the amount of nanoparticles within the fluid range from about 0.0001 wt % to about 10 wt %.

11. A fluid composition comprising:
a base fluid selected from the group consisting of a brine-in-oil emulsion, brine-in-non-aqueous fluid emulsion, a water-in-oil-emulsion, and combinations thereof;
a nanoparticle blend having nanoparticles and an additional component; wherein the nanoparticles selected from the group consisting of graphene, graphene platelets, graphene oxide, nanorods, nanoplatelets, nanoclays, nano-titanium oxide platelets, nano-oxides, and combinations thereof; wherein the additional component is different from the nanoparticles and is selected from the group consisting of nanotubes, graphite, micro-nitrides, and combinations thereof; and wherein the nanoparticles are selected from the group consisting of functionalized nanoparticles, chemically-modified nanoparticles, covalently modified nanoparticles, and combinations thereof;
a surfactant in an amount effective to suspend the nanoparticle blend in the base fluid; and
wherein the nanoparticle blend improves the performance of a high-frequency downhole tool as compared to an otherwise identical fluid absent the nanoparticle blend.

12. A method comprising:
adding an effective amount of nanoparticles to a base fluid to improve the performance of a high-frequency downhole tool as compared to an otherwise identical fluid absent the nanoparticles;
wherein the base fluid is selected from the group consisting of a non-aqueous base fluid selected from the group consisting of an oil-based fluid, a brine-in-oil emulsion, a brine-in-non-aqueous fluid emulsion, a water-in-oil emulsion, and combinations thereof; and;
wherein the nanoparticles are selected from the group consisting of graphene, graphene platelets, graphene oxide, nanorods, nanoplatelets, nanoclays, nano-titanium oxide platelets, nano-oxides, nano-nitrides, and combinations thereof.

13. The method of claim 12, wherein the base fluid is selected from the group consisting of a drilling fluid, completion fluid, a production fluid, a servicing fluid, and combinations thereof.

14. The method of claim 12, wherein the fluid further comprises an additional component that is different from the nanoparticles, wherein the additional component is selected from the group consisting of nanotubes, graphite, micro-nitrides, and combinations thereof.

15. The method of claim 12, wherein after the adding the nanoparticles to the base fluid, the base fluid has at least one property selected from the group consisting of a dielectric constant ranging from about 5 to about 10,000, an electrical conductivity ranging from about 1×10⁻⁶ S/m to about 1 S/m, and combinations thereof.

16. The method of claim 12, wherein the nanoparticles are selected from the group consisting of chemically-modified nanoparticles, covalently-modified nanoparticles, functionalized nanoparticles, and combinations thereof, wherein the modification and/or functionalization of the nanoparticles alters a characteristic of the nanoparticles selected from the group consisting of improving their dispersibility in a non-aqueous fluid, altering the electrical conductivity of the nanoparticles, and combinations thereof as compared with otherwise identical nanoparticles which have not been modified or functionalized.

17. The method of claim 12, wherein the nanoparticles have a dimension no greater than 1000 nm.

18. The method of claim 12, wherein the nanoparticles are functionalized nanoparticles having at least one functional group selected from the group consisting of a sulfonate, a sulfate, a sulfosuccinate, a thiosulfate, a succinate, a carboxylate, a hydroxyl, a glucoside, a ethoxylate, a propoxylate, a phosphate, an ethoxylate, an ether, an amine, an amide, and combinations thereof.

19. The method of claim 12, wherein the nanoparticles are covalently-modified nanoparticles having at least one covalent modification selected from the group consisting of oxidation; fluorination; free radical additions; addition of carbenes, nitrenes and other radicals; arylamine attachment via diazonium chemistry; and the like; and combinations thereof.

20. The method of claim 12, wherein the effective amount of nanoparticles in the fluid range from about 0.0001 wt % to about 10 wt %.

21. A method for modifying the electrical conductivity and the dielectric constant of a fluid, where the method comprises:
adding an effective amount of a nanoparticle blend to a non-aqueous fluid for improving the performance of a high-frequency downhole tool as compared to an otherwise identical fluid absent the nanoparticle blend, wherein non-aqueous fluid is selected from the group consisting of a brine-in-oil emulsion, or a water-in-oil emulsion and combinations thereof; and wherein the nanoparticle blend comprises nanoparticles and an additional component; wherein the nanoparticles selected from the group consisting of graphene, graphene platelets, graphene oxide, nanorods, nanoplatelets, nanoclays, nano-titanium oxide platelets, nano-oxides, and combinations thereof; wherein the additional component is different from the nanoparticles and is selected from the group consisting of nanotubes, graphite, micro-nitrides, and combinations thereof; wherein the nanoparticles are selected from the group consisting of functionalized nanoparticles, chemically-modified nanoparticles, covalently modified nanoparticles, and combinations thereof; and wherein a surfactant is present in the non-aqueous fluid in an amount effective to suspend the nanoparticle blend in the non-aqueous fluid; and
improving the performance of a high-frequency downhole tool as compared to an otherwise identical fluid absent the nanoparticle blend.
